(19) United States
(12) Patent Application Publication
(10) Pub. No.: US 2002/0073680 A1
(43) Pub. Date: Jun. 20, 2002

(54) Leaf rake with one piece, solid tine section

(76) Inventor: A. B. Barajas, Livingston, CA (US)

Correspondence Address: Law Offices of John D. Gugliotta, P.E., Esq., 202 Delaware Building, 137 South Main Street, Akron, OH, 44308, US

(21) Appl. No.: 09/736,770

(22) Filed: Dec. 14, 2000

(51) Int. Cl. A01D 7/00

(52) U.S. Cl. 56/400.1; 56/400.21

(57) ABSTRACT

A leaf rake is provided with a tine section formed of one solid piece of either plastic or sheet metal. Additionally, in lieu of small individual tines, the edge of the rake is composed of a series of rounded, semicircular, scalloped edges.

### RELATED APPLICATIONS

The present invention was first described in Disclosure Document No. 478,623 filed on Aug. 16, 2000. There are no previously filed, nor currently any co-pending applications, anywhere in the world.

### BACKGROUND OF THE INVENTION

1. Field of the Invention

The present invention relates generally to tools for providing a raking function and, more particularly, to a rake having a functionally crenulated grasping edge.

2. Description of the Related Art

Of the many seasonal chores that people perform, the annual gathering and disposal of fallen tree leaves is among the most popular and also the most despised. While many recent devices such as yard vacuums, leaf blowers, mulching mowers and the like have been devised to help in this process, the common rake remains the most popular solution for most people.

However, the common rake does have several disadvantages. First the tines often miss small debris such as small leaves and twigs. Second, the nature of the tines makes them prone to damaging the turf which is being raked. It is not uncommon to see large chunks of grass being removed along with the raked debris. Finally, the spacing between the tines provides an ideal place for retaining or trapping raked debris, which must be periodically removed during the raking process, thus wasting valuable time.

A search of the prior art did not disclose any patents that read directly on the claims of the instant invention; however, the following references were considered related. The following patents disclose the design and function of a rake head.

U.S. Pat. No. 4,744,208 issued in the name of King

U.S. Pat. No. D 392,854 issued in the name of Gregory

U.S. Pat. No. D 293,196 issued in the name of Germain et al.

U.S. Pat. No. D 198,699 issued in the name of Hill

The following patents describe the ornamental design for a sand rake head.

U.S. Pat. No. D 329,785 issued in the name of Colonello

U.S. Pat. No. D 310,619 issued in the name of Schade

U.S. Pat. No. D 282,621 issued in the name of Nuorivaara

U.S. Pat. No. D 274,118 issued in the name of Cochrane

U.S. Pat. No. 5,544,476 issued in the name of South et al. discloses a sand trap rake with oppositely-angled teeth.

U.S. Pat. No. 5,544,435 issued in the name of Somero describes a brush rake for attachment to an excavator arm.

And, U.S. Pat. No. D 393,191 issued in the name of Latto discloses the ornamental design for a sand trap rake with double parallel rows of teeth alternately positioned.

Consequently, there is a need for a means by which raking can be accomplished without the disadvantages as described above.

### SUMMARY OF THE INVENTION

It is therefore an object of the present invention to provide an improved one-piece leaf rake.

It is a feature of the present invention to provide an improved leaf rake having a functionally crenulated grasping edge.

Briefly described according to the preferred embodiment of the present invention, a leaf rake is provided with special enhanced features. Upon initial observation, the invention looks remarkably like a conventional leaf rake with a triangular shaped tine section attached to a wooden or steel handle. But after closer inspection, it can be seen that the tine section is one solid piece of either plastic or sheet metal. Additionally, in lieu of small individual tines, the edge of the rake is composed of a series of rounded, semicircular, scalloped edges.

Such a design allows for easier raking of smaller leaves, twigs, and other items in the grass.

Additionally, the scalloped edge is gentler on the grass and less prone to ripping up sections of the turf.

Finally, and perhaps most important, the solid design of the tines does not allow any leaves or other debris to become caught in the tines, thus eliminating the need to periodically stop and remove such items from a conventional rake.

The use of the solid tine section performs better than conventional rakes in that it will not catch or retain raked material in between tines Further, the solid tine section is less prone to breakage, as well as less prone to missing smaller pieces of raked material.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a leaf rake with one piece, solid tine section according to the preferred embodiment of the present invention;

FIG. 2 is a top plan view thereof;

FIG. 3 is a bottom plan view thereof;

FIG. 4 is a right side elevational view, the opposite side elevational view being a mirror image thereof;

FIG. 5 is a front elevational view thereof; and

FIG. 6 is a rear elevational view thereof.

### DESCRIPTION OF THE PREFERRED EMBODIMENTS

The best mode for carrying out the invention is presented in terms of its preferred embodiment, herein depicted within the Figures.

1. Detailed Description of the Figures

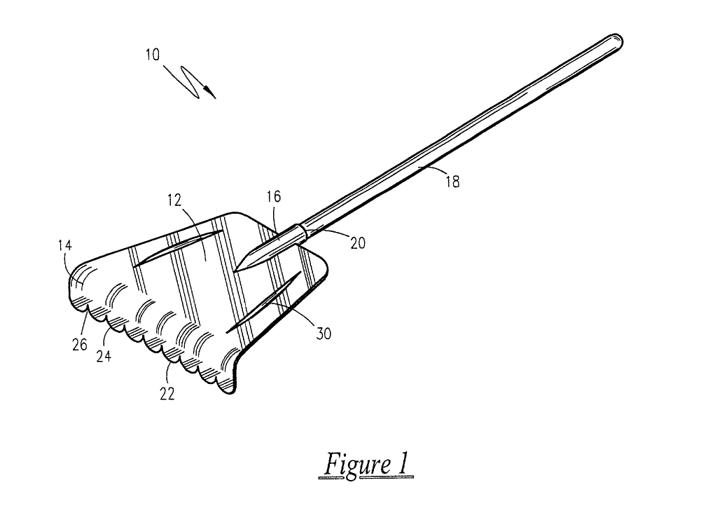

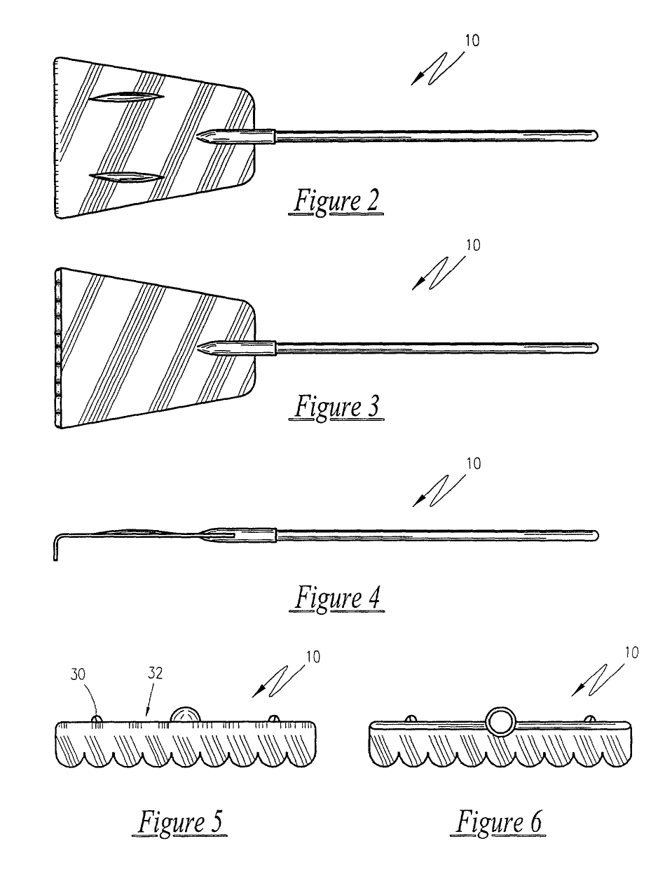

Referring now to FIGS. 1-6, a leaf rake 10 is shown, according to the present invention, having a rake head 12 incorporating a one piece, solid tine section 14 as will be described in greater detail below. The head 12 has a handle attachment means 16 opposite the tine section 14 for connecting to an otherwise conventional cylindrically elongated handle 18. The handle 18 is anticipated as being formed of wood, metal, plastic, or fiberglass. The handle 18 has a head attachment end 20, anticipated as being a male threaded section circumscribing about the outer surface of the head attachment end 20. In this configuration, the handle attachment means 16 is formed as a handle receiving cavity formed integrally within the head 12. The cavity further forms a female threaded inner sidewall for threadingly receiving and securing the male threaded attachment end 20 of the handle.

As could be anticipated by one skilled in the relevant art, various manners of reinforcing the connection between head 12 and handle 18 can be incorporated within the head 12 to provide additional structural rigidity.

Now described in greater detail is the rake head 12 incorporating a one piece, solid tine section 14. The rake head 12 is generally triangular in its overall silhouette. The head 12 is formed in a solid manner, either of plastic or sheet metal. The tine section 14 is formed as a downwardly curved radial surface terminating the base end of the triangularly shaped head 12 opposite the handle 18. Of particular importance to the functional features of the present invention, in lieu of small individual tines as is seen on conventional rakes, the tine section 14 forms a solid surface having a lower grasping edge 22 at the lowermost surface. The grasping edge 22 further forms a series of rounded, semicircular, scalloped protrusions 24, linearly aligned along the edge 22. Separating each scalloped protrusion 24 is a passage notch 26. Finally, in order to provide additional rigidity and spring biasing of the tine section 14, at least one reinforcing rib 30 is formed along the upper surface 32 of the head 12. Such a reinforcing rib 30 can allow for increased structural rigidity while allow for decreased material and weight within the balance of the head.

2. Operation of the Preferred Embodiment

A rake 10 according to the present invention can be easily manufactured of formed plastic, injection molded or thermal formed, or alternately by stamping or other efficient metalworking process. In operation, the present invention is utilized as one would utilize an otherwise conventional rake. However, the crenulated grasping edge will grasp debris such as small leaves and twigs without damaging the turf which is being raked. In this manner, the spacing between the scalloped protrusions will not result in retaining or trapping raked debris, such as will result with a conventional tined rake.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. A leaf rake comprising:
a rake head
a solid tine section formed within said rake head;
a handle attachment means opposite said tine section for connecting to an otherwise conventional cylindrically elongated handle;

2. The leaf rake of claim 1, wherein said handle is formed of a material selected from the group comprising wood, metal, plastic, and fiberglass.

3. The leaf rake of claim 1, wherein said handle has a head attachment end being a male threaded section circumscribing about the outer surface of the head attachment end.

4. The leaf rake of claim 3, wherein said handle attachment means is formed as a handle receiving cavity formed integrally within the head.

5. The leaf rake of claim 4, wherein said cavity further forms a female threaded inner sidewall for threadingly receiving and securing the male threaded attachment end of the handle.

6. The leaf rake of claim 1, wherein said rake head is generally triangular in its overall silhouette and has said tine section formed as a downwardly curved radial surface terminating the base end of the triangularly shaped head opposite the handle.

7. The leaf rake of claim 6, wherein said tine section forms a solid surface having a lower grasping edge at the lowermost surface.

8. The leaf rake of claim 7, wherein said grasping edge further forms a series of rounded, semicircular, scalloped protrusions linearly aligned along the edge.

9. The leaf rake of claim 8, wherein separating each scalloped protrusion is a passage notch.

10. The leaf rake of claim 1, further comprising a lease one reinforcing rib formed along the upper surface for providing additional rigidity and spring biasing of the tine section.
